(19) United States
(12) Patent Application Publication
(10) Pub. No.: US 2004/0161537 A1
(43) Pub. Date: Aug. 19, 2004

(54) Method for coating substrate surfaces

(75) Inventors: Thadeus Schauer, Neuhengstett (DE); Marc Enternmann, Fellbach (DE); Claus D. Eisenbach, Sindelfingen (DE); Waldemar Ph. Oechsner, Ludwigsburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Forschungsinstitut fur Pigmente und Lacke e.V., Stuttgart (DE)

(21) Appl. No.: 10/775,889

(22) Filed: Feb. 9, 2004

Related U.S. Application Data
(63) Continuation of application No. PCT/EP02/08849, filed on Aug. 7, 2002.

(30) Foreign Application Priority Data
Aug. 9, 2001 (DE) 101 40 246.5

(51) Int. Cl. B05D 3/00

(52) U.S. Cl. 427/352

(57) ABSTRACT

The invention relates to a method for coating substrate surfaces, in particular for influencing the hydrophilic or hydrophobic properties thereof. According to the invention, the above effect may be achieved easily and not at great expense and furthermore with a removal of polymer which is not deposited on the surface, whereby a polymer with derivatised hydroxyl and/or carboxyl groups and/or CN, halogen and/or amino substituents is brought into contact with the surface as a solution, the derivatised hydroxyl and/or carboxyl groups or the CN, halogen or amino substituents are subjected to solvolysis, thus converting the polymer into a form with reduced solubility.

The invention relates to a method of coating the surface of substrates in order, in particular, to effect modification of said surface. Such modification in turn serves, in particular, to achieve selective adaptation of the hydrophilicity or hydrophobicity of the surface of the substrates. A further object of the invention relates to the stabilization of particles to counteract flocculation. Another essential field of application relates to improving the resistance of the surface of substrates to ambient media. Furthermore, the substrates can be adapted, via their surface properties, to media with which the substrates will later come into contact or into which they will be introduced or incorporated.

This subject is of interest, for example, for facilitating the incorporation of pigments in paints or lacquers requiring pigmentation and subsequently for maintaining a stable dispersion thereof in the target medium.

Other fields of application comprise the treatment of steel, galvanized steel, aluminum, or aluminum alloys, which will thus be protected from corrosion and can be prepared for the application of strongly adhesive layers of lacquer or paint.

British Patent GB 1,077,422 discloses a pigment dispersion for water-thinned paints and lacquers, in which—to improve the dispersibility of the pigments in the water-diluted state and also to enhance the possibility of redispersing pigments—there is added to the paint or lacquer composition a partially saponified polyvinyl acetate or a water-soluble, partially etherified derivative thereof or a polyvinyl alcohol in a concentration of at least 5 wt % based on the weight of the pigments in the dispersion.

U.S. Pat. No. 4,127,422 A discloses dry pigment compositions, which contain, in addition to the pigment, from 15 to 45 wt % of a non-ionic dispersive agent and from 10 to 67 wt % of a water-dispersible, at least partially hydrolyzed polymer based on vinyl acetate or a polymer based on N-vinylpyrrolidone.

Br. Polym. J. 1996, Vol. 1, pages 266 to 272, discloses investigations on the dispersibility of carbon black, which was tested with eight different types of poly(vinyl alcohol) solution in which the degree of hydrolysis, ie the number of free acetate groups, was varied. The basic assumption was that the poly(vinyl alcohol) component is adsorbed onto the particles of carbon black and consequently the angle of contact of water on particles of carbon black will be changed. It was found that even low adsorption levels are apparently sufficient to produce a hydrophilic surface on the particles of carbon black.

Prior art processes for the production of a homogeneously coated surface of substrates, particularly when in the form of particles, are relatively intricate. For example, U.S. Pat. No. 4,127,422 demands an expensive spray drying step, which in turn requires adequate heat stability on the part of the substrate. Furthermore, this process produces a mixture comprising coated particles, on the one hand, and isolated polymer, on the other hand, ie the polymer used is found to be present in the end product in a deposited form as well as in the pure state.

It is an object of the present invention to provide a method of coating the surface of substrates and, in particular, of affecting their hydrophilicity or hydrophobicity, by means of which this effect can be simply achieved without great expenditure and with which it is also possible to remove any polymer not deposited on the surface.

This object is achieved by the invention with a method as defined in claim 1.

In the process of the invention, solvolysis serves to reduce the solubility of the polymer in the solvent in the presence of the substrate so as to cause deposition and/or immobilization of the polymer on the surface of the substrate. Very pronounced effects can frequently be achieved by this means. The deposition that can be obtained involves more than just adsorption of the polymer onto a surface and makes it possible, in particular, to control the thickness of the deposited layer. Thus the method provides means of building up a desired layer thickness of the coating.

If solvolysis is employed in aqueous media, free hydroxyl and carboxyl groups can be obtained. In alkanol-containing media esters and ethers can be obtained as reaction products.

The number of free hydroxyl or carboxyl groups and thus the degree of hydrophilicity or hydrophobicity imparted on the surface of the substrate can be very simply determined by varying the reaction time.

This can affect the zeta potential, which depends on the number of charge carriers present on the surface.

Frequently, room temperature or a temperature ranging from 20° to 25° C. is adequate for execution of the solvolysis reactions so that the substrate is not subjected to thermal stress.

The polymers used preferably have a molecular weight of from 1,000 to 50,000, particularly when the substrate is a particulate substrate. In the case of flat substrates, the preferred upper limit of the molecular weight is 500,000.

The preferred polymers used in the present invention are selected from the group comprising polyvinyl alcohols, polyacid derivatives, polyvinyl halides, and polyvinyl ethers.

The preferred polyvinyl derivatives include, in particular, polyvinyl esters, eg, polyvinyl acetate, and also polyvinyl alcohol-acetals.

Preferred examples of polyacid derivatives are polyacid esters, eg, maleic acid ester copolymers, polyacrylates and their respective derivatives, polyacid anhydrides, eg, polymaleic anhydride derivatives, and polyacid halides.

In addition, the aforementioned polyvinyl halides and polyvinyl ethers are significant.

Preferred polymers have unsaturated groups (particularly double bonds) in side chains and/or the backbone chain of the polymer molecules.

The solvent used is usually an organic solvent.

The polymers preferably used exhibit active groups or form such groups during solvolysis, which groups serve to immobilize the polymer. Examples of such active groups are carboxyl, amino, hydroxyl, and mercapto groups.

Preferably, the polymer, once it has been deposited onto the surface of the substrate, is modified and at the same time crosslinked. Here immobilization takes place if not already accomplished by the solvolysis reaction. This procedure produces a surface of the substrate having the desired hydrophilic or hydrophobic properties whilst simultaneously effecting stabilization of the coating on the surface.

The crosslinking reaction can take the form of a free-radical reaction or a condensation or addition reaction.

The coating on the surface of the substrate has a certain degree of elasticity and can readily compensate for differences in the coefficients of thermal expansion of the coating and the underlying surface of the substrate. Lifting of the coating from the substrate, such as is observed, for example, on protective brittle oxide layers of aluminum oxide or silicon dioxide or even chromates, is definitely avoided when using the present method and polymer coatings.

The substrate capable of being provided with a surface coating by the present method can be a particulate substrate, or on the other hand it can be a flat substrate such as a sheet of metal.

When the substrate used is a particulate substrate, the polymer used is preferably one having a molar mass of from 1,000 to 50,000 g/mol.

When use is made of flat substrates, the polymer selected is one having a molar mass of from 1,000 to 500,000 g/mol.

In the case of particulate substrates a large number of substrates is suitable, for example pigments, fillers, fibers, nano particles, particles of colloidal or micellar systems or alternatively the aforementioned lamellar particles used in metallic effect lacquers.

The process of the invention is particularly suitable for the application of very thin layers, so-called nano layers, to a surface of a substrate, which nano layers, despite their small layer thickness, can produce dense coverage on the surface of the substrate.

Particularly suitable reactions for immobilization of the deposited layers are partial solvolysis of, say, polymaleic anhydride-polymer derivatives or other reactive polyacid derivatives. It is theoretically possibly to bind—via superficial nucleophilic groups such as OH, NH, or SH groups—the polymer layers to the surface in a subsequent step (eg, heat treatment of the treated substrate).

If, following treatment of a substrate, solvolysis of polyvinyl esters (eg, polyvinyl acetate), a polymaleic anhydride derivative (eg, commercial polystyrene/polymaleic anhydride copolymer) is added followed by partial solvolysis, all of the polymer deposited to form a layer can be immobilized by subsequent heat treatment.

Analogous reactions capable of effecting immobilization are possible using appropriate functionalized polyvinyl halides (eg, polyvinyl acetate/polyvinyl chloride copolymers) or by effecting solvolysis of polyvinyl esters together with polyvinyl halides.

Furthermore, olefinic polymer layers can be relatively easily produced, which make free-radical crosslinking possible. In order to produce these olefinic polymer layers on substrates, esters of polyvinyl alcohol are partially solvated with unsaturated carboxylic acids (eg, cinnamic esters—relatively simply available by a two-phase reaction) in the presence of the substrate. With a suitable choice of solvent and solvolysis conditions there is then formed a polymer layer which can subsequently be free-radically crosslinked.

An olefinic polymer layer can also be produced by, say, solvolysis of polyvinyl acetate derivatives to polyvinylalcohol derivatives in the presence of the substrate. Thermal treatment at a temperature above 150° C. causes water to be eliminated, and conjugated double-bond systems are formed. This elimination of water is greatly facilitated by the presence of carbonyl groups in the polymer.

Particular advantages of the method of the invention are:

Stabilization of particles in dispersions.

Aftertreatment simple to carry out.

Relatively good environmental acceptability due to preferred use of alcohols as solvent.

Control of the hydrophilicity or hydrophobicity by altering the solvolysis conditions, such as type of solvent or the ratio of concentrations.

Control of the loading on a surface by effecting solvolysis of polyacid derivatives once or a number of times.

Simple means of effecting crosslinking/immobilization of the layers and easy removal of excess polymer.

The invention also relates to a substrate having a polymer-coated surface produced by any one of the aforementioned methods of the invention.

Substrates having a coating comprising a so-called nano layer are particularly significant, as are also, in particular, substrates which are metallic substrates.

The present invention is especially significant for surface coating substrates of steel, galvanized steel, aluminum, or aluminum alloy.

The method of the invention can be repeated a number of times, in order to increase the layer thickness of the material deposited onto the surface of the substrate. Particularly in the case of flat substrates, on which higher molar masses of the polymers tend to be more favorable, there is obtained a greater layer thickness per process step or deposition step.

This and further advantages of the invention are illustrated in greater detail below with reference to the examples and drawings, in which:

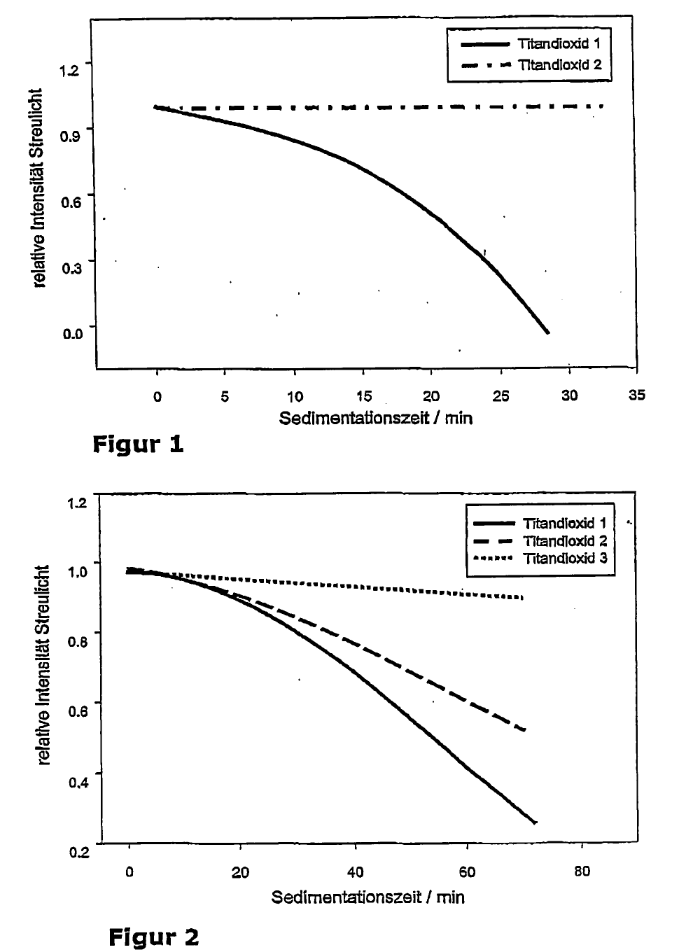

FIGS. 1 and 2 show the settling times of titanium dioxide on different surface coatings;

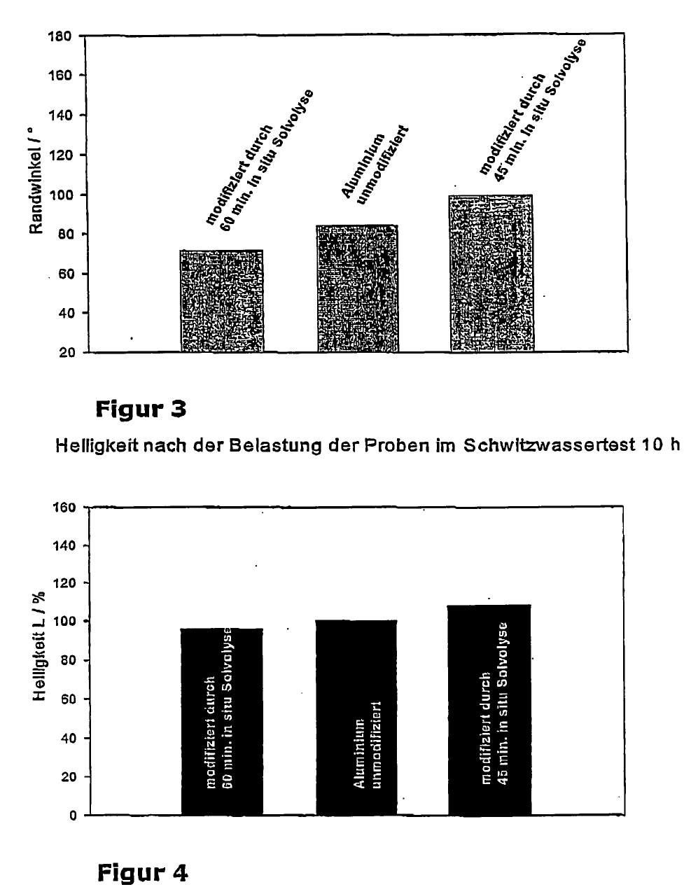

FIG. 3 illustrates the angle of contact as a function of the modification of the surface coating by the solvolysis proposed by the invention; and

FIG. 4 shows the luminosity of various specimens following the condensed water test.

### EXAMPLES

### Example 1

### Treatment of Titanium Dioxide

36 g of titanium dioxide Kronos 2310 are dispersed in a solution of 1.8 g of polyvinyl acetate (ca 17,400 g/mol, sold by Aldrich) in 200 mL of an ethanol/isopropanol mixture (ratio by volume 1:1) in a dissolver using beads of zirconium oxide (ca 3 mm) at 23° C. and 1000 rpm. After 30 min, 1.0 g of KOH, dissolved in 15 mL of isopropanol, are added. After 30 min of solvolysis, 3.0 mL of pure acetic acid are added, and dispersion is carried out for a further 15 min so that the total dispersing time is 75 min. The solvolysis reaction which takes place here is kinetically controlled.

The beads are sifted off and rinsed with 50 mL of isopropanol. The liquid is extracted in a rotary film evaporator in vacuo at 50° C. The pigment cake is then carefully rinsed twice with distilled water to remove the bulk of electrolyte. The pigment is then dried at room temperature.

Titanium dioxide modified by the aforementioned method (solvolysis time 30 min) is well suited for aqueous systems.

If on the other hand the solvolysis is carried out for only 15 min, a titanium dioxide is obtained which is very well suited for organic solvent systems, since in this case a larger amount of residual acetyl groups is still present.

### Results Obtained in Example 1

Titanium dioxide Kronos 2310, treated by 15 min of solvolysis of polyvinyl acetate (molar mass 17,400 g/mol, sold by Aldrich) showed good wetting ability and stabilization properties in organic solvents.

Incorporated in a non-convertible single component polyester/polyacrylic blended lacquer, the layer of lacquer applied to a glass plate and dried thereon showed with the treated titanium dioxide pigment no lifting or blistering when exposed to the condensed water test (DIN 50 017) over a period of 72 h, unlike layers of lacquer pigmented with the original commercial pigment (signs of lifting in several places and formation of relatively large blisters).

In addition, the pigments treated according to the invention were found to be superior to commercial pigments in sedimentation tests. The sedimentation tests were each carried out by weighing 0.1 g of pigment (commercial or treated) into 10 mL of liquid (distilled water as aqueous medium or butyl acetate as organic medium) and dispersing the mixture for 15 min at 23° C. and 3000 rpm with a metal disk. The dispersion was left to stand for a period of 72 h at room temperature, diluted with 8 mL of relevant liquid, and placed in 20 mL test tubes. Settling was monitored by watching the change in the relative scattered light intensity as a function of time at the 10 cm test tube level.

a) Sedimentation Tests in Butyl Acetate

The results of the sedimentation tests shown in FIG. 1 illustrate that for the titanium dioxide (titanium dioxide 2) treated in situ by 15 min of solvolysis according to the above method considerably improved wetting ability and stabilization properties following dispersion in butyl acetate are obtained than for the unprocessed pigment (titanium dioxide 1).

b) Sedimentation Tests in Water

When the same experiments are carried out in water (FIG. 2), it is found that the pigment (titanium dioxide 3) treated according to the above method by 30 min of solvolysis in situ likewise shows better wetting ability and considerably better stabilization properties after dispersion than the other two pigments. The pigment titanium dioxide 2 (retreated by the method proposed in U.S. Pat. No. 4,127,422) shows only slightly improved stabilization in water compared with the unprocessed pigment (titanium dioxide 1).

### Example 2

### Treatment of Flat Substrates Such as an Aluminum Plate

In order to synthesize a suitable soluble polymer having solvolyzable unsaturated ester groups (unsaturated polyvinyl ester), a polyvinyl alcohol having a molar mass of ca 12,000 g/mol was caused to react with acid chlorides in a two-phase reaction according to M. Tsuda, J. Polym. Sci. B, 1, Polym. Letters, 1963, 215. The acid halide component used was cinnamic chloride alone or a mixture of fumaric dichloride (10 mol %), cinnamic chloride (10 mol %), crotonic chloride (25 mol %), and acetyl chloride (55 mol %).

### Coating of Aluminum Plates

1 g of the resulting unsaturated polyvinyl ester was dissolved in a mixture of 12 g of ethanol, 12 g of isopropanol, 5 g of butanol, and 36 g of toluene in a suitable screw cap jar.

In the polymer solution thus produced there were placed aluminum plates (Al 99.5; dimensions: 70×25×1.5 mm), and 100 μL of 15% strength ethanolic potassium hydroxide solution were added.

One of the aluminum plates was taken out after 45 min, briefly rinsed with isopropanol and water, and dried, whilst the second coated aluminum plate was removed from the coating medium after 60 min and likewise briefly rinsed with isopropanol and water. FIG. 3 shows the results of contact angle measurements using distilled water as the liquid phase.

As may be seen from FIG. 3, the decrease in the angle of contact of water is greater the longer the specimens are exposed to solvolysis. Since the degree of solvolysis of polyvinyl alcohol esters using exclusively alcohols as solvent is kinetically controlled (C. A. Finch, Polyvinyl Alcohol—Properties and Applications, John Wiley & Sons, London, 1973), the hydrophilicity of the coating increases with increasing solvolysis time and the angle of contact with water decreases. It was possible to confirm the development of the contact angle, as found, by exposing the specimens to a condensed water test (DIN 50 017). It was to be expected that corrosion of the aluminum specimen in the condensed water test (DIN 50 017) would be greater with increasing hydrophilicity of the coating or decreasing contact angle between the surface and water. Relative estimation of the extent of corrosion can be obtained by making photometric measurements on the specimens subjected to the tests. A high luminosity loss is normally associated with increased corrosion. The results of photometric measurements following a period of 24 h of exposure of the three different aluminum specimens to the condensed water test (DIN 50 017) at 40° C. are shown in FIG. 4. Higher hydrophilicity as reflected by a smaller angle of contact in FIG. 3 is thus associated with an increased tendency to corrosion or a lower luminosity value (FIG. 4).

1. A method of coating the surface of substrates, characterized in that a solution of a polymer having derivatized hydroxyl and/or carboxyl groups and/or CN, halogen, and/or amino substituents is brought into contact with the surface of the substrate and said derivatized hydroxyl and/or carboxyl groups or CN, halogen and/or amino substituents are solvolyzed so that the polymer is converted to a form showing reduced solubility.

2. A method as defined in claim 1, characterized in that solvolysis is carried out only partially.

3. A method as defined in claim 1 or claim 2, characterized in that the polymer has unsaturated groups in side chains and/or the backbone chain.

4. A method as defined in any one of claims 1 to 3, characterized in that the polymer exhibits active groups and/or forms the same during solvolysis, which groups serve to immobilize the polymer.

5. A method as defined in any one of claims 1 to 3, characterized in that after the surface of the substrate has been coated with the polymer, immobilization is effected by means of a crosslinking reaction following the solvolysis.

6. A method as defined in claim 5, characterized in that the crosslinking reaction is a free-radical reaction or an addition or condensation reaction.

7. A method as defined in any one of claims 4 to 6, characterized in that the surface of the substrate is washed following immobilization of the polymer.

8. A method as defined in any one of claims 1 to 7, characterized in that the substrate is a particulate substrate and that the polymer has a molar mass of from 1,000 to 50,000 g/mol.

9. A method as defined in any one of claims 1 to 7, characterized in that the substrate is a flat substrate and that the polymer has a molar mass of from 1,000 to 500,000 g/mol.

10. A method as defined in claim 8, characterized in that the particulate substrate is selected from the group comprising pigments, fillers, fibers, nano particles, and particles of colloidal or micellar systems.

11. A method as defined in any one of claims 1 to 10, characterized in that the surface of the substrate is coated with a nano layer of a polymer.

12. A substrate having a polymer-coated surface, produced by a method as defined in any one of claims 1 to 11.

13. A substrate as defined in claim 12, characterized in that the coating is a nano layer.

14. A substrate as defined in claim 12 or claim 13, characterized in that the substrate is a metallic substrate.

15. A substrate as defined in claim 14, characterized in that the substrate is made of steel, galvanized steel, aluminum, or an aluminum alloy.

16. A substrate as defined in any one of claims 12 to 15, characterized in that the substrate is a particulate substrate, selected from the group comprising pigments, fillers, fibers or lamellar particles, nano particles, and particles of colloidal or micellar systems.
